(19) United States
(12) Patent Application Publication
(10) Pub. No.: US 2008/0127936 A1
(43) Pub. Date: Jun. 5, 2008

(54) Variable pitch timing chain/belt for camshaft to crankshaft correlation

(76) Inventor: Ronald J. Kubani, Highland, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/607,136

(22) Filed: Nov. 30, 2006

(51) Int. Cl. F02P 5/145

(52) U.S. Cl. 123/406.12

(57) ABSTRACT

A timing arrangement for an internal combustion engine includes a timing connection having first and second connection features, each of which include respective properties wherein the second property is greater than the first property. A first timing wheel is fixed for rotation with a crankshaft of the engine. The first timing wheel includes first and second adjacent teeth, wherein the first and second adjacent teeth respectively include first and second widths, which correspond to the first and second connection features, respectively.

### FIELD

The present disclosure relates to internal combustion engines, and more particularly to a timing chain/belt to improve camshaft to crankshaft correlation diagnosis.

### BACKGROUND

The statements in this section merely provide background information related to the present disclosure and may not constitute prior art.

Internal combustion engines induce combustion of an air and fuel mixture to reciprocally drive pistons within cylinders. The pistons rotatably drive a crankshaft, which transfers drive torque to a driveline. Air is drawn into an intake manifold of the engine and is distributed to the cylinders. More specifically, the air, and in some engines the air and fuel mixture, enters the cylinder through one or more intake ports, which are each selectively opened via actuation of a corresponding intake valve. After combustion, the combustion gases are exhausted from the cylinder through one or more exhaust ports, each of which are selectively opened via actuation of a corresponding exhaust valve.

The movement of the intake and exhaust valves, and thus the opening and closing of the intake and exhaust ports, is regulated by intake and exhaust camshafts. As the camshafts rotate, cam lobes of the respective camshafts induce movement of the respective valves. The camshafts are rotatably driven by the crankshaft via a timing chain or belt. The timing chain/belt is wound around gears/pulleys associated with the crankshaft and the camshafts to enable the crankshaft to drive the camshafts.

The movements of the valves are timed to provide opening and closing of the ports at the proper times during the piston strokes. This timing is provided in terms of the rotational position of each of the intake and exhaust camshafts with respect to each other and with respect to the rotational position of the crankshaft. The rotational position of the crankshaft corresponds to the linear position of the pistons within their respective cylinders (e.g., bottom-dead-center (BDC), top-dead-center (TDC)).

The rotational position of each of the camshafts with respect to the crankshaft performs an influential role in the combustion process. For example, the timing of the opening of the intake port with respect to the piston position influences the amount of air that is drawn into the cylinder during the expansion stroke of the piston. Similarly, the timing of the opening of the exhaust port with respect to the piston position influences the amount of combustion product gas that is exhausted from the cylinder.

Accordingly, engine systems include sensors that monitor the rotational positions of each of the camshafts and the crankshaft. More specifically, a target wheel including a known number of teeth is fixed for rotation with each of the respective camshafts and crankshaft. An associated sensor detects the rising and falling edges of the teeth as they pass the sensor and the sensor generates a pulse-train based thereon. Each target wheel includes a gap (e.g., one or two teeth missing) and/or a wider or thinner tooth, each of which operates as a reference point to determine the rotational position of the respective camshafts and crankshaft.

Because the crankshaft drives the camshafts via the timing chain/belt, and because the timing of the intake and exhaust valve movement influences the combustion process, engine systems traditionally monitors the relative rotational positions of the crankshaft position and the camshafts. This is achieved by monitoring the relative positions of the crankshaft pulse-train and the camshaft pulse-trains generated by the respective sensors. If the relative position of the crankshaft to the camshafts deviates by a certain degree, a diagnostic trouble code (DTC) is set indicating a fault with the timing (i.e., relative positions) of the camshafts relative to the crankshaft.

Traditional camshaft to crankshaft timing diagnostics are not as robust as desired. More specifically, traditional diagnostics aren't as accurate as desired and can produce false faults (e.g., setting a DTC when no actual fault exists), or, in some cases, can fail to detect a fault (e.g., fail to set a DTC when a fault exists).

### SUMMARY

Accordingly, the present disclosure provides a timing arrangement for an internal combustion engine. The timing arrangement includes a timing connection having first and second connection features, each of which include respective properties wherein the second property is greater than the first property. A first timing wheel is fixed for rotation with a crankshaft of the engine. The timing wheel includes first and second adjacent teeth, wherein the first and second adjacent teeth respectively include first and second widths, which correspond to the first and second connection features, respectively.

In other features, the timing connection is a timing chain and the first and second connection features each include a chain link. The first and second properties each include a length.

In other features, the timing connection is a timing belt and the first and second connection features each include a belt groove. The first and second properties each include a width.

In still another feature, the timing connection further includes a third connection feature, which includes a third property that is greater than the second property. The first timing wheel includes a third tooth adjacent to the second tooth, wherein the third tooth includes a third width, which corresponds to the third connection feature.

In yet another feature, timing arrangement further includes second and third timing wheels that are fixed for rotation with intake and exhaust camshafts, respectively, of the engine. Each of the second and third timing wheels is drivingly coupled with the first timing wheel through the timing connection.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a functional block diagram of an exemplary engine system in accordance with the present disclosure;

FIG. 2 is a front view of an exemplary timing arrangement of the exemplary engine system of FIG. 1;

FIG. 3 is a partial side view of a traditional timing chain relative to a traditional timing gear;

FIG. 4 is a partial side view of a timing chain relative to a timing gear, both of which are arranged in accordance with the present disclosure;

FIG. 5 is a partial side view of an alternative timing chain relative to an alternative timing gear, both of which are arranged in accordance with the present disclosure; and

FIG. 6 is a partial side view of a timing belt relative to a timing gear in accordance with the present disclosure.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the term module refers to an application specific integrated circuit (ASIC), an electronic circuit, a processor (shared, dedicated, or group) and memory that execute one or more software or firmware programs, a combinational logic circuit, or other suitable components that provide the described functionality.

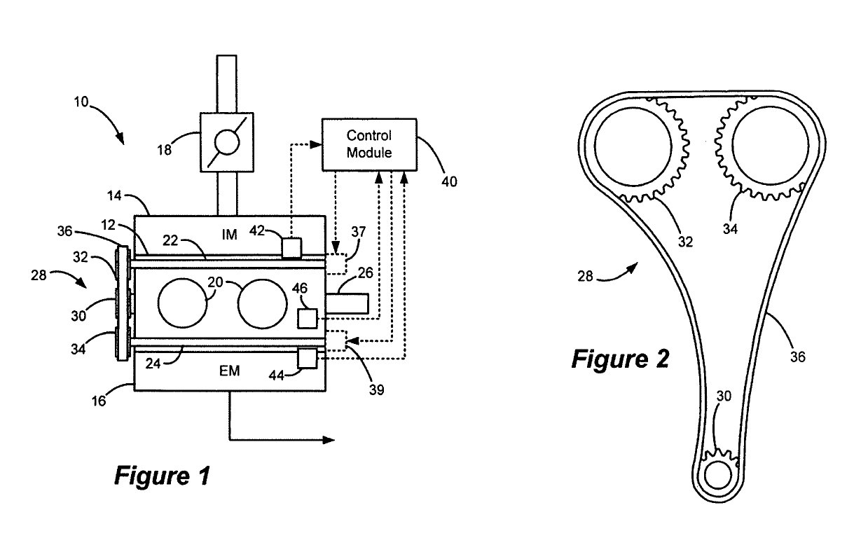

Referring now to FIG. 1, an exemplary engine system 10 includes an engine 12, an intake manifold 14 and an exhaust manifold 16. The engine 12 combusts an air and fuel mixture to generate drive torque. More specifically, air is drawn into the intake manifold 14 through a throttle 18. Although the exemplary engine system 10 includes a throttle 18, it is anticipated that the teachings of the present disclosure can be implemented in an engine system that does not include a throttle.

The air is mixed with fuel to form a combustion mixture that is compressed by a piston (not shown) within cylinders 20. Although only two cylinders 20 are shown, it is appreciated that the teachings of the present disclosure can be implemented in engine systems having one or more cylinders 20. The air, and in some cases the combustion mixture, travels into the cylinder 20 through an intake port (not shown), which is selectively opened by an intake valve (not shown). Combustion of the combustion mixture is induced within the cylinder 20 (e.g., via a spark from a spark plug or the heat of compression). After the combustion event, the product gases are exhaust from the cylinder 20 through an exhaust port (not shown), which is selectively opened by an exhaust valve (not shown). It is anticipated that the engine system 10 can include one or more intake ports and/or exhaust ports with respective intake and exhaust valves.

With particular reference to FIGS. 1 and 2, the movement of the intake and exhaust valves is induced by respective intake and exhaust camshafts 22, 24, which are rotatably driven by the crankshaft 26 via a timing arrangement 28. More specifically, the crankshaft 26 includes a timing wheel 30 and the intake and exhaust camshafts include respective timing wheels 32, 34. A timing connection 36 drivingly interconnects the timing wheels 30, 32, 34 and is provided as a chain, wherein the timing wheels 30, 32, 34 are provided as gears. Accordingly, the timing arrangement is deemed a gear timing connection in this embodiment. In another embodiment, explained in further detail below, the timing connection 36 is provided as a belt, wherein the timing wheels 30, 32, 34 are provided as pulleys.

The crankshaft 26 rotatably drives the intake and exhaust camshafts 22, 24 to open and close the intake and exhaust ports via the corresponding valves in accordance with a desired engine event timing. More specifically, the opening and closing of the intake and exhaust ports are timed with respect to the linear position of the piston within the cylinder 20 and the particular piston stroke. For example, the intake port is opened as the piston leaves the top-dead-center (TDC) position at the beginning of the expansion stroke and travels towards the bottom-dead-center (BDC) position. The linear position of the piston within the cylinder 20 corresponds to a rotational position of the crankshaft 26. Therefore, the rotational positions of the intake and exhaust camshafts 22, 24 correspond to the rotational position of the crankshaft. In order to ensure proper operation of the engine system 10, the relative rotational position of the intake and exhaust camshafts 22, 24 with respect to the crankshaft position must correspond to a desired relative rotational position. In this manner, the timing of the intake and exhaust events accurately correspond to the position of the piston within the cylinder 20.

It is also anticipated that the engine system 10 can include intake and exhaust cam phasers 37, 39, shown in phantom. The cam phasers 37, 39 adjust the angular position of the intake and exhaust camshafts 22, 24 relative to the angular position of the crankshaft 26. In this manner, the opening and closing events of the intake and exhaust valves can be independently adjusted to achieve a desired engine operation.

A control module 40 monitors the rotation of the intake and exhaust camshafts 22, 24 as well as of the crankshaft 26. Sensors 42, 44 respectively monitor the rotational positions of each of the intake and exhaust camshafts 22, 24. A sensor 46 monitors the rotational position of the crankshaft 26. More specifically, respective target wheels (not shown), each of which includes a known number of teeth, are fixed for rotation with each of the respective intake and exhaust camshafts 22, 24 and crankshaft 26. Each sensor 42, 44, 46 detects the rising and falling edges of the teeth of its respective target wheel as they pass the sensor 42, 44, 46 and the sensor 42, 44, 46 generates a pulse-train based thereon. The pulse-trains are provided as signals to the control module 40. Each target wheel includes a gap (e.g., one or two teeth missing) and/or a wider/thinner tooth, each of which operates as a reference point to determine the rotational position of the respective intake and exhaust camshafts 22, 24 and of the crankshaft 26.

By comparing the pulse-trains corresponding to the intake and exhaust camshafts 22, 24 to that of the crankshaft 26, the control module 40 can determine whether the relative position between the crankshaft 26 and the respective intake and exhaust camshafts 22, 24 corresponds to a desired relative position. If not, the timing of the intake and exhaust events does not correspond to a desired timing and a diagnostic trouble code (DTC) is set.

In some instances, the relative rotational positions between the intake and exhaust camshafts 22, 24 and the crankshaft 26 come out of proper alignment or correlation. For example, during engine operation, the timing connection 36 can slip or jump, as explained in further detail below. As another example, the timing connection 36 can be improperly assembled onto the timing gears 30, 32, 34 during original engine assembly and/or subsequent engine maintenance, resulting in an incorrect relative position between the crankshaft 26 and the camshafts 22, 24 for the desired engine timing. Furthermore, the timing connection 26 tends to stretch over the lifetime of the engine system 10, which can compound the problem of determining whether the crankshaft 26 and camshafts 22, 24 are properly aligned. As other examples, part to part variations and temperature effects can also play a role in improper alignment.

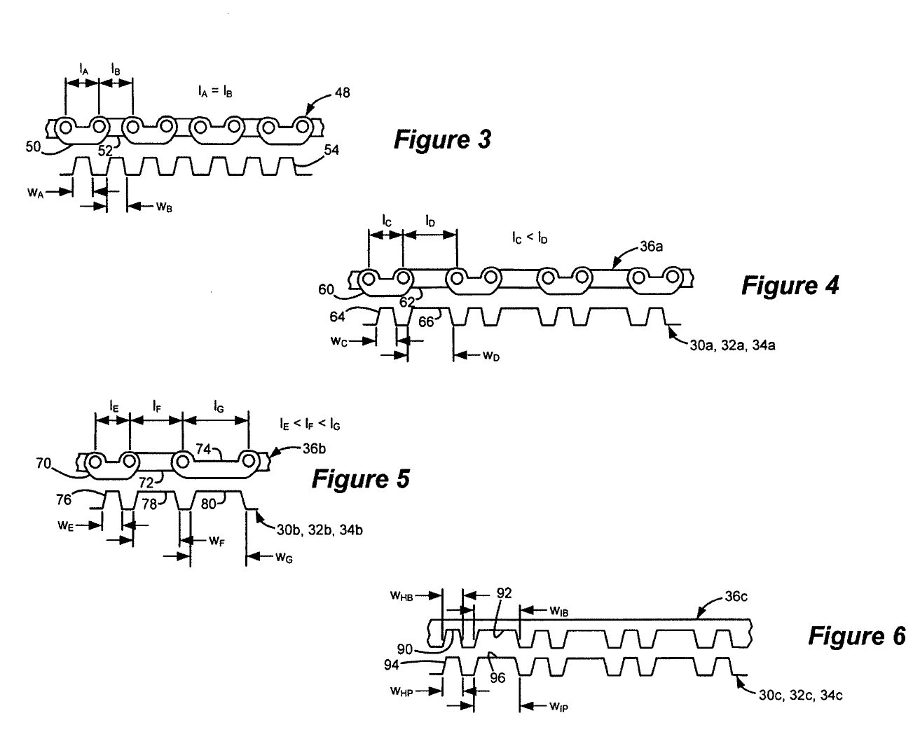

Referring now to FIG. 3, a traditional timing connection is provided as a timing chain 48. The timing chain 48 includes first and second links 50, 52 having equal lengths I_{A}, I_{B}. The first and second links 50, 52 mesh with respective, equidistantly spaced timing gear teeth 54. Although the timing gear teeth 54 are disposed about the curved circumference of the timing gear, it is appreciated that the timing gear teeth 54 are illustrated along a linear axis for purposes of explanation of the present disclosure. Because the first and second links 50, 52 are of the same length and the timing gear teeth 54 are equidistantly spaced and are of the same width, it may be difficult to detect whether the timing chain 48 has slipped (i.e., jumped teeth) during operation of the engine system. More specifically, if the timing chain 48 jumps or is improperly installed, the relative position between the crankshaft and the camshafts may only be a single tooth 54, because every tooth fits into every link 50, 52. A single tooth misalignment is not always readily detectable by the control module. Furthermore, stretching of the chain could be interpreted as a jumped chain, resulting in improper setting of a DTC.

Referring now to FIG. 4, a variable pitch timing connection in accordance with the present disclosure is provided as a variable pitch timing chain 36a. The variable pitch timing chain 36a includes a first link 60 having a first length I_{C} and a second link 62 having a second length I_{D} that is different from the first length I_{C}. More specifically, the second length I_{D} is longer than the first length I_{C}. The first link 60 corresponds to a first timing gear tooth 64 having a first width w_{C} and the second link 62 corresponds to a second timing gear tooth 66 having a second width w_{D}. In this manner, every other link of the timing chain 36a is longer than the adjacent link. This pattern is repeated along the entire length of the timing chain 36a.

If the timing chain 36a was to slip during operation or was to be improperly assembled onto the timing gears 30a, 32a, 34a, the resultant misalignment is more readily recognizable with the timing chain and timing gear configuration of the present disclosure. More specifically, because every other link has a different length and every other timing gear tooth 64, 66 has a different width, the misalignment will be a minimum of two teeth. For example, in the event of a timing chain jump, a smaller length link will not fit over an adjacent wider tooth. Therefore, the smaller length link must jump to a second tooth to mesh with a tooth having a corresponding width. As a result, the misalignment occurs over a minimum of two teeth or two links, which is much more recognizable when comparing pulse-trains and is not readily confusable with a stretched timing chain.

An alternative timing chain 36b and corresponding timing gear 30b, 32b, 34b are illustrated in FIG. 5. The timing chain 36b includes a first link 70 having a first length I_{E}, a second link 72 having a second length I_{F} and a third link 74 having a third length I_{G}. The second length I_{F} is longer than the first length I_{E} and the third length I_{G} is longer than the second length I_{F}. The timing gear 30b, 32b, 34b includes first, second and third teeth 76, 78, 80 having first, second and third widths w_{E}, w_{F}, w_{G}, respectively, which correspond to the first, second and third links 70, 72, 74 of the timing chain 36b, respectively. This pattern is repeated along the length of the timing chain 36b. With this arrangement, the minimum misalignment occurs over three teeth. More specifically, each of the links is only able to receive every third timing gear tooth. Therefore, if a misalignment were to occur, it would occur by a minimum of three teeth, which will result in a significant deviance in the relative position between the crankshaft 26 and the camshafts 22, 24, as detected based on the pulse-train comparison.

Referring now to FIG. 6, it is anticipated that the timing connection 36 can be provided as a timing belt 36c. In this case, the timing belt 36c includes grooves 90, 92 formed in an inside surface. The grooves 90, 92 of the timing belt 36c correspond to teeth 94, 96 of timing pulleys 30c, 32c, 34c. The grooves 90, 92 include respective widths w_{HB}, w_{IB} and the teeth 94, 96 include corresponding widths w_{HP}, w_{IP}. In accordance with the present disclosure, every other groove 92 of the timing belt 36c is wider than the immediately adjacent groove 90. This pattern is repeated along the length of the timing belt 36c. Furthermore, every other tooth of the timing pulley 30c, 32c, 34c is wider than the immediately adjacent teeth, corresponding to the pattern of the timing belt 36c. The arrangement of FIG. 6 functions similarly to that of FIG. 4, wherein a misalignment occurs over a minimum of two teeth.

It is anticipated that the above-described tooth or gap patterns can be formed to provide for a misalignment over any number of teeth. Although misalignments over two and three teeth are described in detail above, it is anticipated that the present invention can be further modified to provide a misalignment over four or more teeth, for example.

In summary, the present disclosure provides a timing arrangement for an internal combustion engine and a control system for monitoring operation of the engine, which incorporates the timing arrangement. The timing arrangement includes a timing connection, such as a timing chain or belt, having first and second connection features. The connection features include, for example, links, in the case of a timing chain, and grooves, in the case of a timing belt. The connection features include respective first and second properties, wherein the second property is greater than the first property. The properties include, for example, a length, in the case of a timing chain, and a width, in the case of a timing belt. A first timing wheel is fixed for rotation with a crankshaft of the engine. The first timing wheel includes one of a gear or a pulley depending on whether the timing connection is provided as a chain or a belt. The timing wheel includes first and second adjacent teeth, wherein the first and second adjacent teeth respectively include first and second widths, which correspond to the first and second connection features, respectively.

Those skilled in the art can now appreciate from the foregoing description that the broad teachings of the present disclosure can be implemented in a variety of forms. Therefore, while this disclosure has been described in connection with particular examples thereof, the true scope of the disclosure should not be so limited since other modifications will become apparent to the skilled practitioner upon a study of the drawings, the specification and the following claims.

What is claimed is:

1. A timing arrangement for an internal combustion engine, comprising:
a timing connection having first and second connection features having first and second properties, respectively, wherein said second property is greater than said first property; and
a first timing wheel that is fixed for rotation with a crankshaft of said engine, wherein said first timing wheel includes first and second adjacent teeth, wherein said first and second adjacent teeth respectively include first and second widths, which correspond to said first and second connection features, respectively.

2. The timing arrangement of claim 1 wherein said timing connection is a timing chain, and wherein said first and second connection features each include a chain link.

3. The timing arrangement of claim 2 wherein said first and second properties each include a length.

4. The timing arrangement of claim 1 wherein said timing connection is a timing belt, and wherein said first and second connection features each include a belt groove.

5. The timing arrangement of claim 4 wherein said first and second properties each include a width.

6. The timing arrangement of claim 1 wherein said timing connection further includes a third connection feature, which includes a third property that is greater than said second property, and wherein said first timing gear includes a third tooth adjacent to said second tooth, wherein said third tooth includes a third width, which corresponds to said third connection feature.

7. The timing arrangement of claim 1 further comprising second and third timing wheels that are fixed for rotation with intake and exhaust camshafts, respectively, of said engine, wherein each of said second and third timing wheels are drivingly coupled with said first timing wheel through said timing connection.

8. A control system for monitoring operation of an internal combustion engine, comprising:
a timing arrangement, comprising:
a timing connection having first and second connection features having first and second properties, respectively, wherein said second property is greater than said first property;
a first timing wheel that is fixed for rotation with a crankshaft of said engine, wherein said first timing wheel includes first and second adjacent teeth, wherein said first and second adjacent teeth respectively include first and second widths, which correspond to said first and second connection features, respectively; and
a second timing wheel that is fixed for rotation with a camshaft of said engine, wherein said second timing wheel includes third and fourth adjacent teeth, wherein said third and fourth adjacent teeth respectively include third and fourth widths, which correspond to said first and second connection features, respectively; and
a control module monitors a relative rotation between said crankshaft and said camshaft and selectively sets a diagnostic trouble code based on said relative rotation.

9. The control system of claim 8 further comprising first and second sensors that respectively monitor rotational positions of said crankshaft and said camshaft, respectively.

10. The control system of claim 8 wherein said timing connection is a timing chain, and wherein said first and second connection features each include a chain link.

11. The control system of claim 10 wherein said first and second properties each include a length.

12. The control system of claim 8 wherein said timing connection is a timing belt, and wherein said first and second connection features each include a belt groove.

13. The control system of claim 12 wherein said first and second properties each include a width.

14. The control system of claim 8 wherein said timing connection further includes a third connection feature, which includes a third property that is greater than said second property, and wherein said first timing wheel includes a third tooth adjacent to said second tooth, wherein said third tooth includes a third width, which corresponds to said third connection feature.
